(19) United States
(12) Patent Application Publication
(10) Pub. No.: US 2004/0091836 A1
(43) Pub. Date: May 13, 2004

(54) Dental appliance and method for holding and repositioning a veneer during bonding and cementation process

(76) Inventor: Marc Lazare, Jericho, NY (US)

Correspondence Address: KENYON & KENYON, ONE BROADWAY, NEW YORK, NY, 10004, US

(21) Appl. No.: 10/651,375

(22) Filed: Aug. 28, 2003

Related U.S. Application Data
(63) Continuation-in-part of application No. 10/156,451, filed on May 28, 2002.

(51) Int. Cl. A61C 3/00

(52) U.S. Cl. 433/163; 433/141

(57) ABSTRACT

One embodiment is a dental appliance, and another embodiment is a method for using a dental appliance to position a veneer, for example a ceramic or porcelain laminate veneer, on the surface of a tooth. One embodiment of the dental appliance comprises a plurality of grippers, allowing a dentist to adjust the position and hold a veneer on the tooth during the bonding process. Another embodiment of the dental appliance comprises one gripper, allowing a dentist to adjust the position and hold a veneer on the tooth during the bonding process. One embodiment of the method includes repositioning of the veneer using a dental appliance, holding the veneer with the dental appliance while excess adhesive is removed and a light source probe is used to cure a localized area of a light-sensitive adhesive, again repositioning the veneer using the dental appliance, and holding the veneer with the dental appliance during curing of another localized area.

### CROSS-REFERENCE TO RELATED APPLICATION

This application claims the benefit under 35 U.S.C. §120 of patent application Ser. No. 10/156,451, filed May 28, 2002, the contents of which is incorporated herein by reference.

### FIELD OF THE INVENTION

The present invention relates to a dental appliance and a method for positioning a veneer, for example a ceramic or porcelain laminate veneer, on the surface of a tooth. The dental appliance has at least one gripper, allowing a dentist to adjust the position and hold a veneer on the tooth during the bonding process.

### BACKGROUND OF THE INVENTION

The materials used in veneering vary, including composite resins, customized pre-shaped laminates and porcelain/ceramic shells. Each dental veneer is individually crafted and applied to the front surface of a tooth. The materials are specially selected to match the color and translucency of natural teeth. Veneers improve the cosmetic appearance of stained and/or damaged teeth, and are typically bound to the surface of teeth using an adhesive.

The common practice during bonding of a veneer to a tooth is for a dentist to hold the veneer in place during bonding with his or her finger. This practice has several shortcomings. For example, a typical bonding process requires the use of a light probe to cure a light sensitive adhesive. However, the finger of the dentist obscures the veneer, and makes it difficult to both see the veneer and to direct the light to the portion of the veneer that the dentist wants to cure.

Furthermore, the dentist may need to reposition the veneer prior to curing the adhesive, and a single finger in a wet protective glove that may have sticky adhesive on one part and may be slippery on another part can have the tactile sensation impaired, slipping in relation to the veneer. Slipping can cause a failure in the bonding of the veneer, for example positioning the veneer incorrectly, compromising the integrity and aesthetics of the veneer. Typically, force must be applied to the veneer both lingually (in the direction of the tooth) and cervically (toward the gums) to seal the margins of the veneer. If a veneer slides incisally (toward the chewing surface of the tooth), mesially (toward the rear of the jaw), or distally (toward the middle of the front of the jaw) during or prior to the bonding process and adheres to the tooth, then the application of the veneer can be unsatisfactory aesthetically. Margins that are not properly sealed can require the veneer to be removed by drilling away the veneer and adhesive from the surface of the tooth, causing patient discomfort, a prolonged procedure, and replacement by a new veneer.

Some dental appliances have been disclosed to replace a dentist's finger during this process. For example, the following U.S. patents disclose various instruments that can be used to pick-up and/or hold a veneer: U.S. Pat. No. 5,040,981, “Dental Restoration Holder and Placement Tool,” issued to Oliva on Aug. 20, 1991, disclosing a tool with a tip that has a tacky substance and, alternatively, thin is tabs with adhesive for picking up, placing, and holding a veneer; U.S. Pat. No. 4,953,902, “Device for Adhesively Holding Small Objects,” issued to Brown on Sep. 4, 1990, disclosing a tool having a tip with a plunger that dispenses an adhesive for picking up, placing and holding a veneer; and U.S. Pat. No. 4,822,278, “Dental Veneer Instrument,” issued to Oliva et al. on Apr. 18, 1989, having a tool adapted for use with a vacuum source and a transparent suction tip. Nevertheless, most dentists continue to use their fingers to pick up, place and hold the veneer in place during bonding, because known appliances do not apply pressure evenly over the surface of the veneer and do not give sufficient pressure feedback to the dentist.

Also, dentists often need to reposition the veneer on the tooth prior to or during the bonding of the veneer to the tooth. This can require the application of a torque (twisting force) to twist the veneer or the application of a lateral force to slide the veneer into the correct position. Known appliances often slip or come unbound from the veneer when such a torque or force is applied to the veneer. Dentists often are forced to use two fingers to reposition the veneer, and then, by default, the dentist must hold the veneer with a finger while curing the adhesive. This often leaves excess, cured adhesive visible on the tooth that must be subsequently removed by drilling, grinding or polishing.

Appliances that adhere to a veneer by suction or adhesive slip less than plastic probes without suction or adhesive, but the adherence between the appliance and the veneer can exert a negative pressure or pulling on the veneer, particularly during repositioning, removal of glue prior to bonding or following bonding during removal of the appliance from the veneer. Pulling on the veneer is undesirable. A suction or pulling force during or after the bonding process can cause the veneer to debond or cause voids in the adhesive layer between the tooth and the veneer. In addition, the known appliances often fail to apply sufficient torque or pressure to reposition a veneer prior to and, especially, during bonding.

### SUMMARY OF THE INVENTION

The present invention is directed to a dental appliance and a method for positioning a veneer using a dental appliance that gives the dentist good visibility while permitting the dentist to hold and reposition the veneer prior to and during bonding.

In one embodiment, the dental appliance has a handle, and on one end of the handle is a head having a plurality of grippers. For example, the plurality of grippers can comprise four flexible grippers, each flexible gripper can be fixedly or removably attached to a head, which can be fixedly or removably attached to the handle. Furthermore, the grippers can be spaced apart such that the dentist can apply a positive pressure evenly over the surface of the veneer. In another embodiment of the invention, the head and grippers alone are claimed as a replacement head for a dental appliance, as illustrated by FIG. 2, for example.

In another embodiment, the dental appliance has a handle, and on one end of the handle is a head having one gripper. For example, the gripper can be in any shape, such as for example, an oval, rectangle or square, and it can be fixedly or removably attached to a head, which can be fixedly or removably attached to the handle. Furthermore, the gripper can be contoured and flexible such that it will fit any tooth and the dentist can thereby apply a positive pressure evenly over the surface of the veneer. In another embodiment of the invention, the gripper (or grippers) alone is claimed as a replacement part for a dental appliance, as illustrated by FIG. 11, for example.

In one embodiment of the method, the dentist places a veneer, which has previously had adhesive applied on the lingual side of the veneer, on a tooth in a patient's mouth. Then, the dentist uses a dental appliance with one hand, positioning a plurality of grippers of the dental appliance on the exposed surface of the veneer. Next, the dentist checks the position of the veneer and, if necessary, repositions the veneer by applying force, such as torque and shear forces, on the veneer via the grippers, ensuring that the margins are sealed. When the veneer is properly positioned, the dentist holds the veneer in place by applying positive lingual and cervical pressure on the grippers and, if necessary, removes excess adhesive from around the margins. Then, a light probe is introduced and the veneer is tacked in one localized area. The dentist can again check the position of the veneer and, if necessary, reposition the veneer, for example by applying torque on the veneer via the grippers, and holding the correctly positioned veneer in place with positive pressure, reintroduce the light probe and cure the adhesive in at least one additional localized area. In a further embodiment of the method of the invention, these same steps can be performed with the embodiment of the dental appliance having one gripper.

In an embodiment of the invention the dental appliance with flexible grippers, or one flexible gripper, limits the positive pressure applied to the veneer to a pressure range within a reasonable positive pressure. Herein a reasonable positive pressure is in the lingual direction and within a range greater than zero and less than a pressure that would cause discomfort to a patient, mar the surface of the veneer, or damage the tooth. For example, a typical range would help the dentist to limit the pressure to no greater than the pressure typically used by a dentist who is repositioning and holding a veneer with a finger. More preferably, the limit of pressure can be the pressure exerted by the dental appliance by a force limited to a range greater than zero or less than one pound, wherein the force is applied by the dentist to the dental appliance.

As an embodiment of the invention, a dental appliance has one or more pads that have a soft, non-slip material in contact with the dental veneer, such that a dentist can hold and reposition the dental veneer prior to and during a bonding process without marring the surface of the dental veneer. The pad may be removable and replaceable or fixed on a gripper.

Herein, a material is soft if it is sufficiently elastic, plastic, and/or elasto-viscoplastic such that the material conforms to a surface in contact with the material without marring the surface of the material. Also, a material is considered non-slip herein, if the slippage across a surface of a particular material is sufficiently negligible that the material is useful for applying typical torque and shear forces to the surface of the particular veneer via the non-slip material during normal repositioning of the dental veneer. As one example, a latex coating having a thickness approximately equal to a latex glove can be used on a conforming pad that will come into contact with a composite laminate veneer to provide sufficient non-slip properties to the conforming pad. More preferably, the pad can be made of silicone rubber for a conforming pad that will come into contact with a porcelain veneer.

As one embodiment of the invention, the method of bonding the veneer improves the quality of the bonding process, reducing the tendency for margins to be left unsealed, reducing the time for bonding the veneer to the tooth, and reducing patient discomfort.

### BRIEF DESCRIPTION OF THE FIGURES

For the purpose of illustrating the invention, representative embodiments are shown in the accompanying figures, it being understood that the invention is not intended to be limited to the precise arrangements and instrumentalities shown.

FIG. 1 shows an embodiment of the dental appliance in relation to a dental veneer, as it is used in the method of holding and repositioning a dental veneer during bonding.

FIG. 2 illustrates an embodiment of the invention, the head of a dental appliance.

FIG. 3 shows another alternative embodiment of the dental appliance in relation to a dental veneer, as it is used in the method of holding and repositioning a dental veneer during bonding.

FIG. 4 illustrates a close-up view of only a portion of the handle, the head and four grippers of one embodiment of the dental appliance, and the close-up is shown in relation to a dental veneer, as it is used in the method of holding and repositioning a dental veneer during bonding, while the normal component of the applied load is at its upper limit, and the grippers are fully depressed.

FIG. 5 shows an example of a stiffened tubular handle having a non-circular cross section.

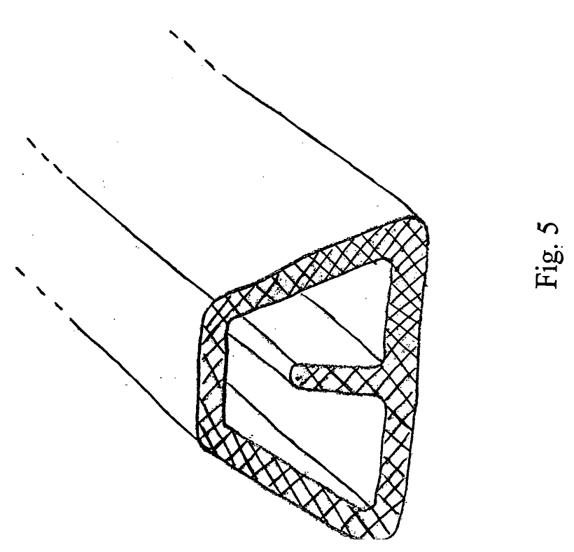

FIG. 6 illustrates a flexible elbow, which connects a portion of the stem to the end effector, according to one of the embodiments of the invention.

FIG. 7 shows a reticulated, flexible elbow having a fastened joint and a spring, which connects a portion of the stem to the end effector, according to one of the embodiments of the invention.

FIG. 8 illustrates a cross section of a hollowed handle, according to one of the embodiments of the invention.

FIG. 9 shows an embodiment of the dental appliance of the invention having one gripper.

FIG. 10 shows a further embodiment of the dental appliance of the invention.

FIG. 11 shows an embodiment of the dental appliance of the invention wherein the plurality of grippers have been removed from the head.

### DETAILED DESCRIPTION OF THE PREFERRED EMBODIMENTS

The present invention will now be described in detail for specific preferred embodiments of the invention. These embodiments are intended only as illustrative examples and the invention is not to be limited thereto.

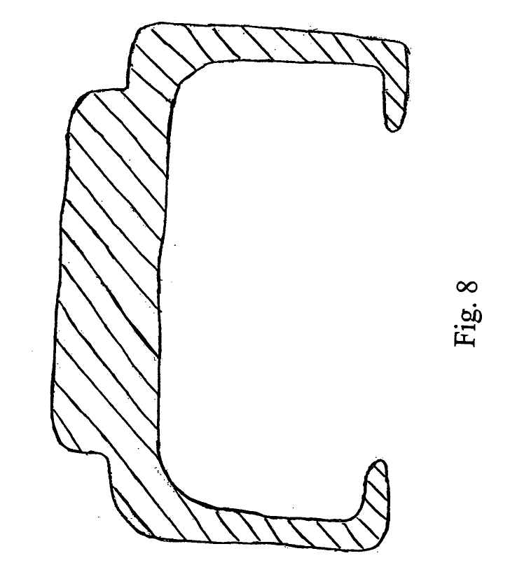

A head can be attached to a handle 10 that is made of a rigid material, for example an autoclavable plastic. Alternatively, the handle can be disposable or chemically sanitizable. In yet another alternative, the handle can be metal, ceramic, or a glass filled polycarbonate. The handle can be solid or, more preferably, the handle can be at least partially hollowed. For example, the handle can be tubular. More specifically, it can be a circular tube, a tube with a square cross section, or a stiffened tubular design, for example. The handle can also be hollowed by removing material from the handle, for example. An illustration of one cross section of a hallowed handle with material removed from the handle is shown in FIG. 8, for example. The handle can be a single material, or the handle can be made from more than one material. For example, the handle can have a soft, non-slip grip, where the appliance is held, to prevent slipping between the grip and the dentist's gloved hand. In one embodiment the grip is textured 12. Furthermore, the handle can be curved to give better access to the teeth at the back of the mouth. For example, the handle can have a bend that allows use in the rear of the left-rear of the patient's mouth. Alternatively, it can a have a rotatable head to reach into either the left-rear or right-rear of a patient's mouth.

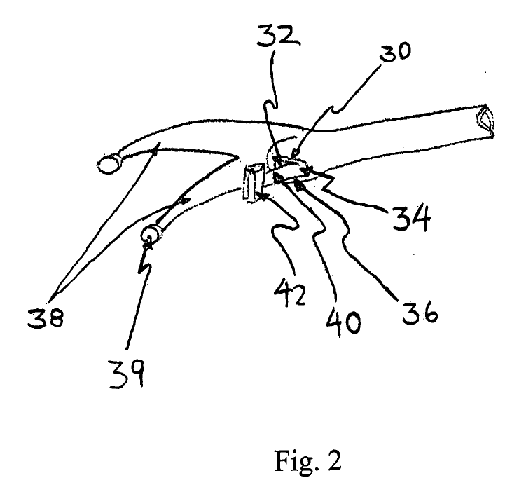

One embodiment of the present invention is a replacement head for a dental appliance having a head, and three grippers, as shown in FIG. 2. The head 19 is attached to the handle and provides a transition between the handle and the grippers. The head can be the same material as the handle and can be seamlessly integrated with the handle. Alternatively, the head can be a different material than the handle and, for example, can be joined to the handle by insertion of the head into the handle. In one embodiment the head is fixedly attached to the handle, for example the head can be integrally molded with the handle or adhesively bonded to the handle. In an alternative embodiment, the head is removably attached to the handle. The head can be either autoclavable or nonautoclavable, and can be reusable or disposable.

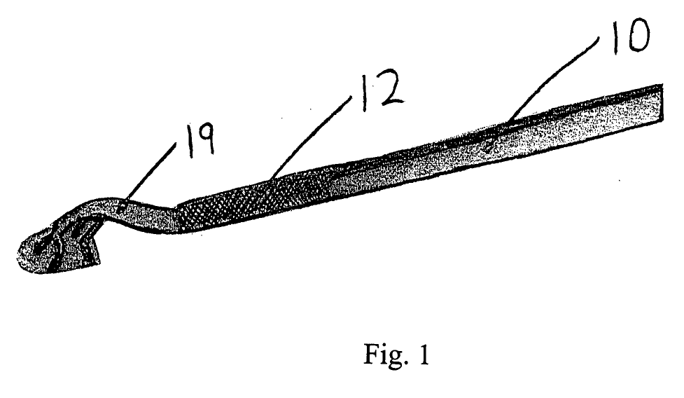

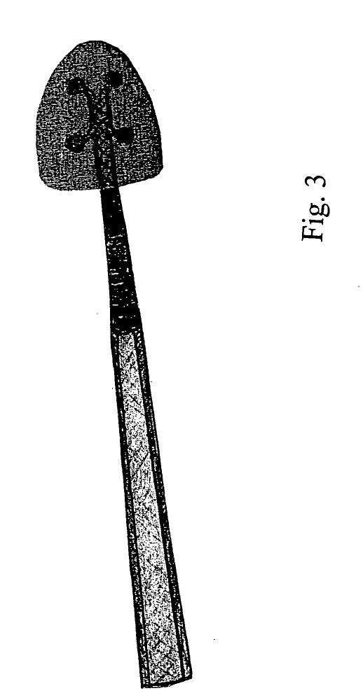

In another embodiment, there are four grippers attached to the head, as illustrated in FIGS. 1, 3, and 4, for example. As one example, each gripper can comprise a prong extending from the head and have a flexible tip attached to the prong by a flexible elbow. Each tip can have a soft, non-slip is contact pad for contacting the veneer without damaging the surface of the veneer. The material of the soft, non-slip pad can be a material that does not slip on the surface of the veneer, even when the veneer is wet, so long as sufficient pressure is applied by the dentist during holding or repositioning of the veneer. For example, the material can be a flexible, elastic material, such as an elastomer or can be another material coated by an elastomer. Alternatively, the pad can be a soft plastically deformable material. Yet another alternative is for the pad material to be an elasto-viscoplastic material. For example, some typical materials are a silicone rubber, a butyl rubber, a chrolinated butyl rubber, a fluoroelastomer, an acrylate, a bromo butyl rubber, a transparent natural rubber, a TPE, a chloroprene rubber (e.g., Neoprene™)*, an ethylene acrylic rubber, an ethylene propylene, a fluorocarbon rubber, a fluorosilicone rubber, a polymer-based putty, a styrene-butadiene rubber and a nitrile rubber. In one embodiment a pad is fixedly attached to the end of a gripper. In an alternative embodiment a pad is removably attached to the end of a gripper, such that it can be removed and replaced after use. *Neoprene™ is a trademark of the DuPont Corporation.

One embodiment uses a gripper material that is compatible with insertion into the mouth of a patient at a composition of the elastomer that keeps the contact soft and prevents slipping of the contact on the surface of the veneer under a reasonable positive pressure that is applied by the dentist. A reasonable positive pressure is within a range of pressure from nearly zero psi to a pressure less than a pressure that would cause damage to a veneer or tooth or discomfort to the patient. More preferably, the force applied by the dentist to hold the veneer in place is greater than zero but less than one pound. More preferably still, the pressure should be about the same as the pressure applied by the finger of a dentist to hold the veneer in place, according to the current practice. One specific embodiment is a polycarbonate coated by a layer of silicone rubber that is two millimeters in thickness.

In one specific embodiment of the invention, the dental appliance comprises a handle, a head, and a plurality of grippers. In one specific embodiment, as shown in FIG. 2, the number of grippers attached to the head is three, and the rearward gripper has a pad 42 that is shaped to fit on the incisal edge of the veneer to grip the edge of the veneer. Alternatively, the two forward grippers and the rearward gripper each have a flat pad 39 that is soft and non-slip.

In a specific embodiment of the invention, the rearward end of the head is attached or, alternatively, attachable to a handle. In yet another embodiment the head is integrally attached to the handle. For example, the handle and the head can be integrally formed of an autoclavable polymer resin by injection molding.

In the embodiment as shown in FIG. 2, the grippers that are attached to the head form a triangular arrangement. Specifically, FIG. 2 shows the triangular arrangement having two forward grippers 38 extending from the forward portion of the head and one rearward gripper 32 extending from the rearward portion of the head. However, the invention encompasses a plurality of grippers, including, but not limited to, two, three, four, or five grippers, which can be arranged in a variety of geometric arrangements, such as diagonal (e.g., lower left to upper right); vertical (one incisal, the other cervical); horizontal (one left; one right); triangular (e.g., two cervical and one incisal or vice versa); square or rectangular (e.g., two cervical; two incisal); or diamond (one incisal, two intermediate and one cervical). For example, one embodiment of a gripper, as illustrated by FIG. 2, has a conforming pad 42 attached to the extending member 40, which is attached to the stem 30 by a flexible elbow 34.

Furthermore, the head and grippers can, alternatively, be sized for different sizes of dental veneers. For example, the spacing between the grippers can be either closer or further apart to size the particular head small, medium, or large to accommodate the size of the patient's particular veneer, wherein the veneer size depends on the size of the patient's tooth and the space between teeth.

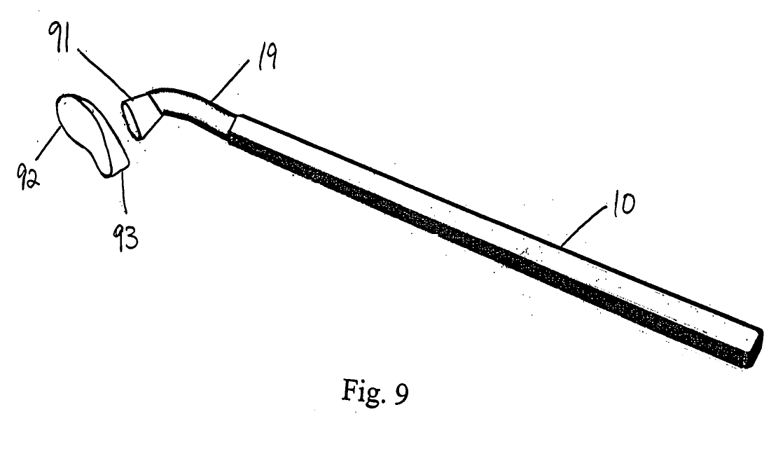

In an embodiment of the invention as shown in FIG. 9, the dental appliance can include a handle, a head and one gripper. In this embodiment, the handle 10 is attached to a first end of the head 19. The handle 10 may be fixedly or removable attached to the head 19. A second end of the head 19 is attached to a first end of a gripper 91. The gripper 91 may be fixedly or removable attached to the head 19. The gripper 91 is preferably made of any pliable material, such as for example, silicon rubber. The second end of the gripper, which is opposite of the head, is also contoured, such that the second end of the gripper may be pliably flexed in such a way to fit over or onto a tooth 92 of a patient. In this way, the second end of the gripper may be used to place a veneer 93 onto a tooth 92. In FIG. 9, the gripper 91 is in the shape of an oval, however, this gripper can be in any shape, including but not limited to, a square, a rectangle, or a trapezoid.

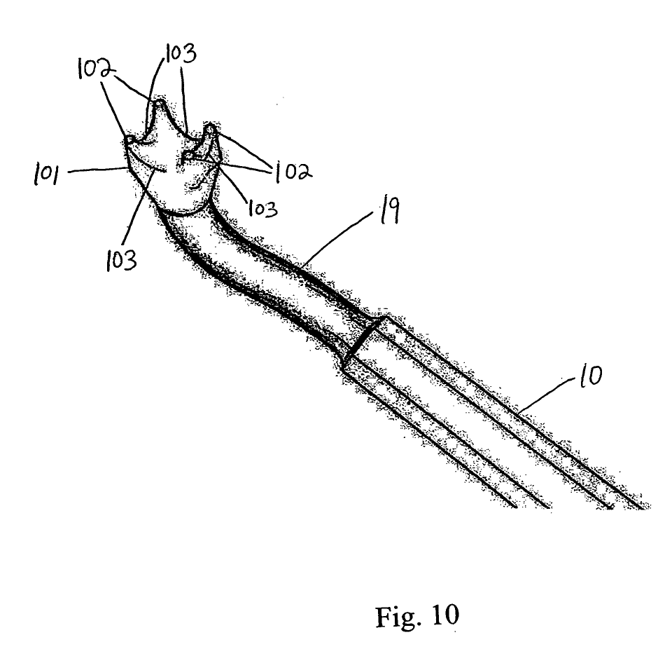

In another embodiment of the invention, the dental appliance can include a handle, a head, and a plurality of grippers, wherein the plurality of grippers are comprised of a single piece of pliable material. In this embodiment of the dental appliance as shown in FIG. 10, the handle 10 is attached to a first end of the head 19. The handle 10 may be fixedly or removable attached to the head 19. A second end of the head 19 is attached to a first end of a plurality of grippers 101. The plurality of grippers 101 may be fixedly or removably attached to the head 19. The plurality of grippers 101 are preferably made of a pliable material, such as for example, silicon rubber. As can be seen in FIG. 10, in this embodiment each of the plurality of grippers (of which there are four in a trapezoidal configuration in FIG. 10) comprises a raised portion 102 of the single piece of the pliable material. Preferably, the portions 103 of the single piece of pliable material which are between the raised portions 102 which form the grippers are in the form of an inverted arch, which serve to stabilize and flex the raised portions 102 which form the grippers when the grippers are subject to pressures of normal use, such as for example, about one pound.

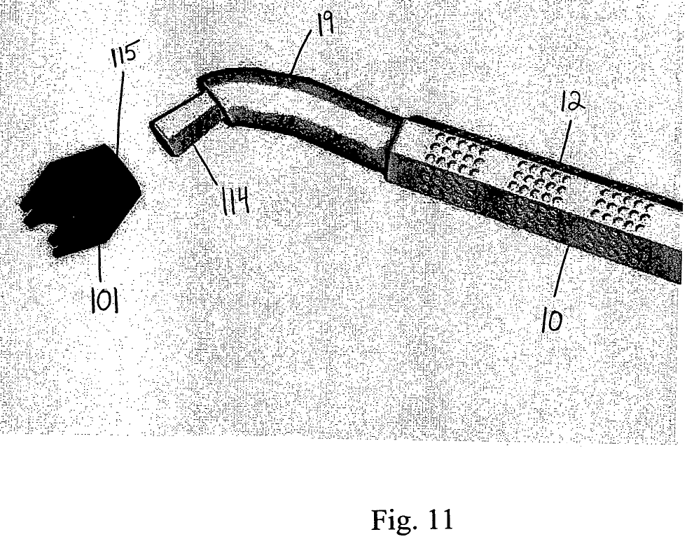

In the embodiment of the invention shown in FIG. 11, the plurality of grippers 101 have been removed from the head 19. Thus, in this embodiment, when the plurality of grippers 101 are attached to the head 19, the plurality of grippers 101 are removably attached to the head 19. As seen in FIG. 11, the end of the head 19 includes a male coupling 114, while an end of the plurality of grippers 101 includes a female coupling 115. The shape of this male/female coupling can be any shape in which a male/female coupling can occur. In the embodiment shown in FIG. 11, the male coupling 114 and the female coupling 115 are both in the form of a hexagonal design. Furthermore, in this embodiment, the female coupling 115, and thus the plurality of grippers 101, may be rotatably moved around the male coupling 114, which would allow for easy positioning of the plurality of grippers 101 for access to upper, lower, and posterior teeth, for example. Any embodiment of the dental appliance of the present invention, regardless of the number or type of grippers included therein, may employ such a male/female coupling arrangement for removably attaching the gripper(s) to the head, and/or the head to the handle.

In one preferred embodiment, the grippers are spaced apart such that a light source, which is used to cure the light-curable adhesive, can access the surface of the veneer between two or more of the grippers. In the embodiment shown in FIG. 2, there is sufficient space between each of the three grippers and the other grippers for the light source to cure the adhesive between the grippers. For example, this allows the dentist to cure the adhesive at two or more locations without removing and repositioning the dental appliance on the surface of the veneer.

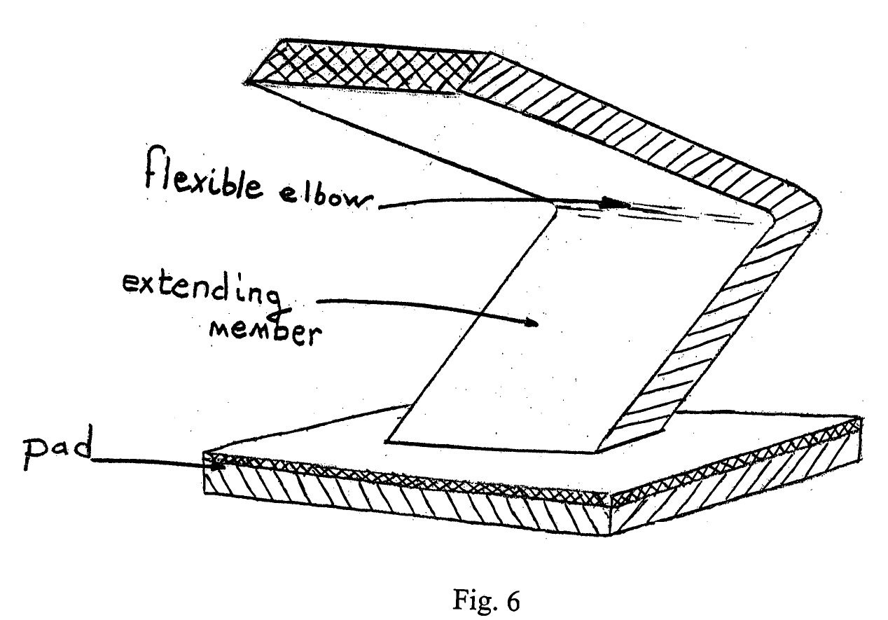

In one typical embodiment of the invention, the gripper has a stem having a first end attached to the head of dental appliance and a distal end attached to a flexible elbow. The flexible elbow connects the distal end of the stem to an end effector, for example FIG. 6. The end effector comprises the part of the dental appliance that comes into direct contact with the surface of the veneer. In one embodiment of the invention, the end effector is a soft and flexible elastomeric pad on an extending member, as shown in FIG. 6, for example.

The soft, non-slip pad in FIG. 6 is a compound pad comprising a silicone rubber foot that is adhesively bonded to a flexible plate, and the flexible plate is attached to the extending member. Alternatively, Alternatively, the pad can extend up the surface of the extending member. In a specific embodiment, the material of the end effector is selected to be non-slip on the surface of a veneer made of a particular material, such as silicone rubber for a porcelain veneer. The pad can have a lenticular shape, such that the pad is less likely to slip on the surface. More preferably, the lenticular shape is very slight, such that the pad does not act effectively as a suction cup, sticking to the surface, but merely allows even more flexibility in the conforming of the pad to the surface. Even more preferably, the surface of the pad is textured, such that the ridges of the textured pad make intimate contact with the surface of the veneer and grip the surface of the veneer without any suction between the pad and the surface of the veneer.

The pad can include a layer of a tacky substance (e.g., sticky rubber or adhesive), which tends to make the pad non-slip. More preferably, any tacky substance will cause only a negligible tensile force on the surface of the veneer when the dental appliance is removed from the surface of the veneer, during repositioning of the dental appliance, for example. Other embodiments are also possible, so long as the pad is elastically, plastically, and/or visco-plastically soft and non-slip on the surface of a particular veneer. The extending member joins the pad to the flexible elbow, and the soft pad can extend up along the surface of the extending member.

In a typical embodiment, the flexible elbow flexes within an imaginary plane intersecting the stem, the flexible elbow, and the extending member in response to the normal component of the force applied to the surface of the veneer. The dentist will apply, through the handle of the dental appliance, a force on the dental veneer while holding and repositioning the veneer during bonding. This force can be resolved into a normal component, a shear component, and a torsional component of the applied force.

The normal component of the applied force pushes (positive) or pulls (negative) in a direction perpendicular to the surface of the veneer. More preferably, the pads are made of a material that provides a negligible negative normal component of applied force. The shear component of the applied force is tangential to the surface of the veneer and tends to cause the veneer to slide across the surface of the tooth. The torsional force (or torque) is a twisting force that tends to cause the veneer to rotate on the surface of the tooth.

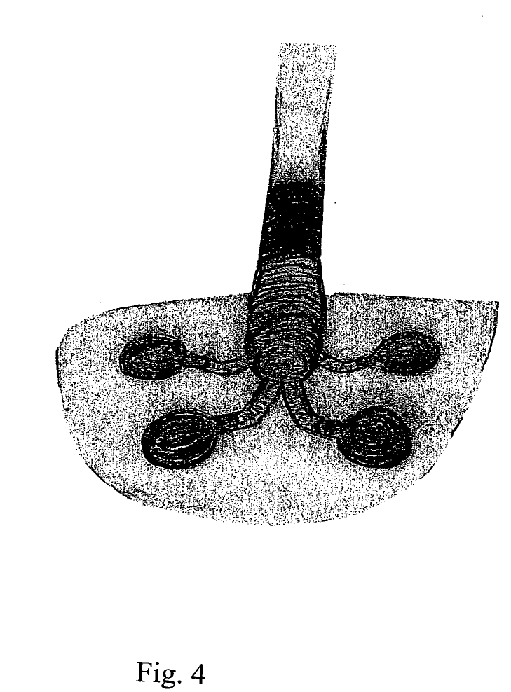

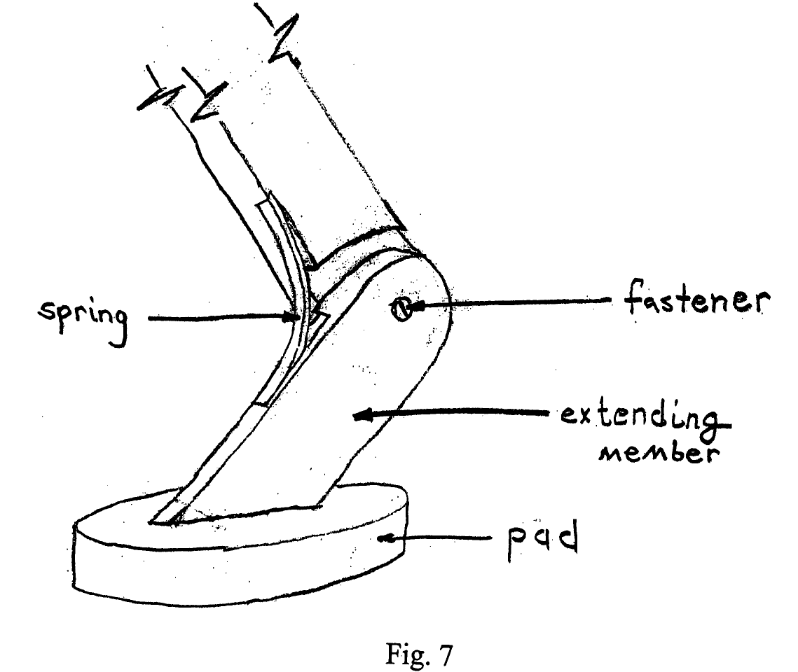

In the embodiments shown in FIGS. 6 and 7, the flexible elbow has greater rigidity to torque and shear forces than to the normal component of the applied force. Therefore, the forces that are non-normal to the surface of the veneer are transmitted to the surface of the veneer with little flexing of the flexible elbow. However, the normal component of the applied force causes an elbow on one or more grippers to flex, which provides the dentist with visual and tactile feedback, allowing the dentist to limit the normal component of the applied force. In one preferred embodiment, the amount of force required to completely depress the flexible grippers, e.g., FIG. 4, is about one pound; therefore, the range of the normal component of force for this preferred embodiment is between zero and about one pound. The dentist can both see and feel that the maximum pressure has been reached, when the flexible grippers are completely depressed. Therefore, the dentist can avoid exceeding the preferred limit on the normal component of the force. By the term “about” one pound, the inventors suggest that the limit on the normal component of the applied force is on average one pound, but it is known that this limit will vary substantially during manufacturing of grippers and between manufacturers who are subcontracted to fabricate dental appliances, within ordinary manufacturing tolerances. Therefore, the actual limit can be greater or less than one pound, depending on manufacturing conditions, specified tolerances, and tolerances actually achieved by a particular manufacturer. Also, it is understood that, while a limit of about one pound is a preferred embodiment, other limits could be selected and are within the scope of the invention, up to a normal component of the applied force that would mar the surface of a particular veneer material, damage the patient's tooth, or cause an unacceptable level of discomfort to the patient. The preferred embodiment of about one pound was selected to limit the thickness and softness required for the soft, non-slip pads, and for the comfort of the patient.

In one example, shown in FIG. 6, the shape and material of the elbow are such that the elbow is flexible in response to a normal component of the applied force, but is more rigid in response to non-normal forces. The rectangular cross section of the stem, flexible elbow and extending member acts like a spline, stiffening the gripper to torque and shear forces. Other shapes are known that will similarly allow sufficient flexibility to normal forces, while stiffening a gripper to non-normal forces, and are within the scope of the invention. In addition, splines of one material may be combined with a flexible elbow of another material to stiffen the flexible elbow to non-normal forces.

In another example, e.g., FIG. 7, the flexible elbow is reticulated such that it can bend in response to the normal component of the applied force, but is rigid in response to non-normal forces. Therefore, non-normal forces are transmitted to the surface of the veneer through the grippers. In FIG. 6, a spring transmits the normal component of the applied force to the surface of the veneer through the flexible gripper, wherein the preferred range of the normal component of the applied force can be limited by giving the dentist visual and tactile feedback, allowing the dentist to limit the normal component of the applied force to a force less than or equal to that causing fully depressed flexible elbows.

A dental veneer can be bound to a tooth by curing, with a light source probe, a light-sensitive adhesive that is sandwiched between a tooth and the dental veneer, using the dental appliance disclosed herein to hold and reposition the dental veneer. One preferred process includes the following steps. First, position the dental appliance on the surface of a veneer such that the is single gripper, or each of the plurality of grippers, makes contact with the surface of the veneer. Next, a force is applied to the dental appliance, repositioning the veneer on the tooth, if necessary, by applying torsional and shear forces through the gripper or grippers of the dental appliance. Then, optionally, the dentist removes any excess adhesive. While holding the veneer under an applied force having at least a normal component and a shear component in the cervical direction, a light source probe is introduced to cure at least one localized area of the light-sensitive adhesive. Herein, “localized area” means a spot large enough to hold the veneer in place under its own weight and any negligible negative pressure induced by removal and repositioning of the dental appliance on the tooth. Then, after optionally removing and repositioning the dental appliance, applying a force to reposition the dental veneer and curing at least one additional localized area. Finally, the dental appliance is removed, and the remaining uncured areas of the light-sensitive adhesive are cured.

What is claimed is:

1. A dental appliance comprising:
a handle;
a head, wherein a first end of the head is attached to the handle; and
a gripper, wherein a first end of the gripper is attached to a second end of the head, and wherein the gripper comprises a pliable material which is contoured and flexible such that a second end of the gripper will pliably fit a tooth of a patient.

2. The dental appliance of claim 1, wherein the first end of the gripper is removably attached to the second end of the head.

3. The dental appliance of claim 2, wherein the second end of the head comprises a male coupling, and the first end of the gripper comprises a female coupling.

4. The dental appliance of claim 3, wherein the male coupling is in the form of a hexagonal design, and the female coupling is in the form of a hexagonal design.

5. The dental appliance of claim 4, wherein the female coupling may be rotatably moved around the male coupling.

6. The dental appliance of claim 5, wherein the pliable material comprises a silicon rubber.

7. The dental appliance of claim 1, wherein the pliable material comprises a silicon rubber.

8. The dental appliance of claim 1, wherein the first end of the gripper is fixedly attached to the second end of the head.

9. The dental appliance of claim 1, wherein the second end of the gripper is in the shape of an oval, a rectangle, a square, or a trapezoid.

10. A dental appliance comprising:
a handle;
a head, wherein a first end of the head is attached to the handle; and
a plurality of grippers, wherein a first end of the plurality of grippers is attached to a second end of the head, wherein the plurality of grippers are comprised of a single piece of pliable material, and wherein each of the plurality of grippers comprises a raised portion of the single piece of pliable material.

11. The dental appliance of claim 10, wherein the first end of the plurality of grippers is removably attached to the second end of the head.

12. The dental appliance of claim 11, wherein the second end of the head comprises a male coupling, and the first end of the plurality of grippers comprises a female coupling.

13. The dental appliance of claim 12, wherein the male coupling is in the form of a hexagonal design, and the female coupling is in the form of a hexagonal design.

14. The dental appliance of claim 13, wherein the female coupling may be rotatably moved around the male coupling.

15. The dental appliance of claim 14, wherein the single piece of pliable material comprises a silicon rubber.

16. The dental appliance of claim 10, wherein the single piece of pliable material comprises a silicon rubber.

17. The dental appliance of claim 15, wherein the plurality of grippers comprises four grippers, and wherein a portion of the single piece of pliable material between the raised portions is in the form of an inverted arch.

18. The dental appliance of claim 17, wherein the four grippers are arranged in a trapezoidal configuration.

19. The dental appliance of claim 10, wherein the first end of the plurality of grippers is fixedly attached to the second end of the head.

20. A method of bonding a dental veneer to a tooth by curing, with a light source probe, a light-sensitive adhesive that is sandwiched between a tooth and the dental veneer, using a dental appliance, comprising:
positioning the dental appliance on the surface of a veneer, wherein a gripper makes contact with the surface of the veneer;
after the step of positioning the dental appliance, repositioning the dental veneer on the tooth to seal all of the margins between the dental veneer and the tooth, wherein the step of repositioning comprises applying torsional and shear forces through the gripper of the dental appliance;
after the step of repositioning the dental veneer, removing any excess adhesive while holding the dental veneer in place with the dental appliance;
after the step of repositioning the dental veneer, adhering the veneer, wherein the step of adhering comprises, in sequence:
holding the veneer in place by applying a force to the veneer using the dental appliance, wherein the applied force has at least a normal component and a shear component in the cervical direction;
introducing a light source probe;
curing at least one localized area of the light-sensitive adhesive;
repositioning the dental veneer using the dental appliance;
curing at least one additional localized area; and
removing the dental appliance, whereby the remaining uncured areas of the light-sensitive adhesive can be cured.
